(19) United States
(12) Patent Application Publication
(10) Pub. No.: US 2023/0043263 A1
(43) Pub. Date: Feb. 9, 2023

(54) A BLENDER FOR A POWDER-BASED BEVERAGE

(71) Applicant: Princigo Labs Ltd, Potters Bar (GB)

(72) Inventor: Christopher Varnavides, London (GB)

(21) Appl. No.: 17/792,669

(22) PCT Filed: Jan. 15, 2021
(86) PCT No.: PCT/GB2021/050090

§ 371 Date: Jul. 13, 2022

(30) Foreign Application Priority Data
Jan. 15, 2020 (GB) 2000610.2

(51) Int. Cl. A47J 43/042; A47J 43/046; A47J 43/07; A47J 43/27; A47J 31/00; A47J 31/40

(52) U.S. Cl. CPC A47J 43/042; A47J 43/046; A47J 43/0716; A47J 43/27; A47J 31/005; A47J 31/404; A47J 31/407

(57) ABSTRACT

A detachable capsule-breaching head for a beverage-mixing device. The capsule-breaching head comprises a capsule 48-container body having a first body part which is telescopically movable on an actuation axis A relative to a second body part. The capsule-breaching head further has at least one capsule-receiving chamber in the first body part and a capsule-breaching element at the second body part movable relative to the capsule-receiving chamber on the actuation axis A. A discharge guide element guides a powder released from a capsule, an openable closure element sealingly closes the discharge guide element, and a removable access cover closes an access opening of the capsule-receiving chamber.

The present invention relates to a blender for a beverage which is preferably powder-based. The invention further relates to a detachable capsule-breaching head for a beverage-mixing device.

Powders, such as nutritional powders, are commonly mixed with liquids, such as water or milk, to form a powder-based beverage. Powder-based beverages are typically quick to prepare and consume and so may be prepared and consumed by a user on-the-go, for example by a user at an exercise facility. Additionally, since a local liquid supply can be used, for example a local water supply, a user is only required to transport the powder rather than entire beverage.

However, some nutritional powders can be difficult to mix or dissolve in liquids and may form clumps within the liquid, rather than a uniformly smooth beverage as may be desired. As such, users are typically required to vigorously shake their beverage holder in order to reduce the amount of clumping within the beverage. Such shaking can be time consuming and strenuous. Therefore, it is desirable to provide a way of better mixing or dissolving a powder within a liquid when on-the-go to form a powder-based beverage.

Additionally, nutritional powders are typically formulated so that a given amount of nutritional powder should be mixed with a given amount of liquid to form a beverage. Such formulation is for providing the user with a desired amount of nutrients, for providing a beverage with a desired taste and/or for providing suitable miscibility. As such, a user is conventionally required to measure the said amount of powder at home, and suitably store the said amount of powder for transportation for use on-the-go. As well as being time-consuming, such measuring and preparation can be inaccurate and therefore a user may consume a beverage with the incorrect quantity of powders which may impact on nutritional intake and/or beverage enjoyment.

Furthermore, a user may wish to create a bespoke beverage with multiple different powders to create a beverage with a bespoke nutritional content or taste. Measuring separate quantities of powders consumes additional time.

It would therefore be desirable to provide to a user a pre-loaded closed or sealed container, capsule or cartridge of powder for forming a powder-based beverage. However, quickly removing the entirety of the powder, or a significant proportion thereof, from the closed container, capsule or cartridge may be challenging. This is particularly if the powder has a large particle size, and/or does not flow adequately.

The present invention seeks to provide a solution to these problems.

According to a first aspect of the invention there is provided a detachable capsule-breaching head for a beverage-mixing device, the capsule-breaching head comprising: a capsule-container body having a first body part which is telescopically movable on an actuation axis relative to a second body part, at least one capsule-receiving chamber in one of the first and second body parts of the capsule-container body, a capsule-breaching element for breaching a capsule received in the capsule-receiving chamber, the capsule-breaching element being at the other of the said first and second body parts of the capsule-container body and movable relative to the capsule-receiving chamber on or parallel to the said actuation axis, a discharge guide element for guiding a powder released from a capsule by the capsule-breaching element, an openable closure element for sealingly closing the capsule-receiving chamber and the discharge guide element, and a removable access cover for closing an access opening of the capsule-receiving chamber.

The beverage-mixing device includes portable or non-portable mixing devices. In particular, the detachable capsule-breaching head is for a portable blender. However, the capsule-breaching head may be used with any container in which mixing may be performed, such as a gym shaker, a vacuum flask or a coffee cup.

The capsule, which is at least part prefilled with powder, allows for a user to discharge a desired amount of powder without requiring the user to first measure the quantity of powder. The first body part being movable on an actuation axis relative to the second body part allows for the capsule-breaching element to create an opening in a wall or surface of the capsule. In particular, the first body part being telescopically moveable relative to a second body part, so as to breach the capsule, provides a convenient means of opening the capsule. For example, a pressing or pushing motion can be used to breach the capsule, rather than a twisting motion, for example.

Preferably, the capsule-breaching element may include a plurality of piercing elements which upstand on or parallel to the actuation axis. A plurality of piercing elements, rather than a single larger breaching element, can create a smaller surface area for contacting the capsule, and therefore reduces the amount of initial force required to breach the capsule.

Beneficially, the piercing elements may define a flap-creation device for creating a flap from a capsule wall of the capsule. The creation of a flap, in particular one which pivots outwardly, allows for a larger opening to be made with reduced force required, since the capsule-breaching element can engage the capsule with a smaller surface area. This is due to the flap-creation device breaching part of the way around a perimeter of an opening, rather than breaching the entire area of the opening. A larger opening allows for powder with relatively low flowability to be discharged from the capsule. A flap, which prevents a part of the capsule from being disconnected from the capsule, is beneficial since part of the capsule is not completely disconnected from the remainder of the capsule. Therefore, the risk of part of the capsule contaminating the beverage is reduced or eliminated.

Advantageously, the piercing elements may define a rim of an arcuate discontinuous wall. The piercing elements defining a discontinuous wall permits for the presence of an uncut portion of the capsule to act as a hinge for the flap portion of the capsule. Additionally, the arcuate discontinuous wall may be defined by two spaced-apart arcuate wall-parts.

Beneficially, each piercing element may be a pointed tooth. The pointed tooth can have a fine tip or edge which reduces the area which contacts the capsule, and therefore reduces the amount of initial force required to initially breach the capsule.

In a preferable embodiment, the discharge guide element may include a discontinuous truncated frusto-conical surface which forms at least part of an interior surface of the arcuate discontinuous wall. The frusto-conical surface provides a slope to guide and funnel the discharged powder. This permits the capsule-breaching element to upstand without the creation of an underlying step which could trap powder thereon.

Optionally, the discharge guide element may include or define an aperture through a base of the second body part. As such, the powder can be directed to an underlying mixing body.

Additionally, the arcuate discontinuous wall may upstand from a base of the second body part. This assists with ensuring that the capsule is fully perforated along the extent of the capsule-breaching element.

Preferably, a plurality of said capsule-receiving chambers may be in the first body part of the capsule-container body. A plurality of capsule-receiving chambers allows for different types or quantities of powders to be discharged into the mixing body simultaneously.

Advantageously, the capsule-receiving chambers may be equiangularly spaced around a central axis of the head.

Beneficially, the or each said capsule-receiving chamber may have a uniform or substantially uniform lateral extent along at least a majority of the longitudinal extent. In this way a capsule-receiving chamber is configured to receive a cylindrical capsule, and could, for instance, receive such a capsule in at least two orientations.

In a preferable embodiment, the or each said capsule-receiving chamber may have a longitudinal axis which is on or in parallel to the actuation axis. As such, a lower end surface of the capsule can be conveniently breached by the capsule-breaching element. However, it will be appreciated that the capsule-receiving chamber may have a longitudinal axis which is at an angle to the actuation axis. For example, the longitudinal axis of the capsule-receiving chamber may be perpendicular or substantially perpendicular to the actuation axis. Additionally or alternatively, the capsule-receiving chamber may have an opening at or adjacent to a side wall of the capsule-container body.

Additionally, the capsule-breaching head may further comprise a biasing element which biases the first and second body parts away from each other. This assists with reverting the first and second body parts to their original arrangement, which may allow for the capsules to be conveniently removed from the chamber, as well as priming the capsule-breaching head for breaching further capsules.

Optionally, the closure element may be rotatably engaged with the second body part. This permits the capsule-breaching head to adopt a closed or sealed configuration by moving the closure element, or an associated control or handle, in a circumferential direction.

Preferably, the capsule-breaching head may further comprise a releasable locking element which prevents or limits relative movement of the first and second body parts when the closure element is angular displaced to close the capsule-receiving chamber and the discharge guide element. This prevents or limits unintentional actuation of the first and second body parts with the closure element in a closed condition.

Alternatively, the closure element may be removably engagable with the first body part, preferably with a distal end of the first body part, and even more preferably with the access opening of the capsule-receiving chamber in the first body part. This arrangement prevents contents of the capsule and/or fluid from the beverage-mixing device, which has in use entered the detachable capsule-breaching head, from leaking or seeping out of the first body part and out of the detachable capsule-breaching head.

Additionally, the closure element may be positioned at or adjacent to the removable access cover. Preferably, the closure element may be provided on an interior surface of the removable access cover. This simplifies operation, as closing of the capsule-receiving chamber and the discharge guide element by the closure element and the closing of the access opening of the capsule-receiving chamber by the removable access cover can take place simultaneously.

Preferably, the capsule-breaching head may further comprise a releasable locking element which prevents or limits relative movement of the first and second body parts when the removable access cover is engaged with the capsule-container body to close the access opening of the capsule-receiving chamber and the closure element is engaged with the first body part to close the capsule-receiving chamber and the discharge guide element.

According to a second aspect of the invention, there is provided a portable beverage-mixing device comprising a mixing body including a container for holding a liquid to be mixed with a powder dischargeable from at least one capsule; and a capsule-breaching head according to a first aspect of the invention and which is releasably engagable with an end of the said container, the said discharge guide element of the capsule-breaching head, when the capsule-breaching head is engaged with the container, being in flow communication with an interior of the container.

Preferably, the capsule-breaching head may be screw-threadingly engagable with the said container. This allows for the container and the capsule-breaching head to be conveniently releasably attached together.

Advantageously, said removable access cover of the capsule-breaching head is separately releasably engagable with the container. This permits the container to be closed by the removable access cover and so allow for a mixed beverage to be stored for later consumption.

Beneficially, the portable beverage-mixing device may further comprise a releasable mixer body which is engagable with a second end of the said container and which is opposite the first said end.

Optionally, the mixer body may house a power source, an electric motor which is energisable by the power source, and at least one blending element for blending contents in the container and which is drivable by the electric motor. An electrically blending element can provide a uniform consistency of beverage with limited physical or manual input by the user. A power source housed in the mixer body allows for the blender to be portable.

According to a third aspect of the invention, there is provided a capsule-breaching device comprising: a capsule-container body, at least one capsule-receiving chamber in the capsule-container body, a capsule-breaching element which is movable to breach a capsule received in the capsule-receiving chamber, and a discharge guide element for guiding a powder released from a capsule by the capsule-breaching element.

Preferably, the capsule-container body may have a first body part which is movable relative to a second body part. In particular, the first body part may be telescopically movable on an actuation axis relative to the second body part. Optionally, at least one capsule-receiving chamber may be in one of the first and second body parts of the capsule-container body. Additionally, the capsule-breaching element may be at the other of the first and second body parts of the capsule-container body. The capsule-breaching element may be movable relative to the capsule-receiving chamber on or parallel to the actuation axis.

The capsule-breaching device may further comprise an openable closure element for sealingly closing the discharge guide element.

Preferably, the capsule-breaching device may further comprise a removable access cover for closing an access opening of the capsule-receiving chamber.

Optionally, at least part of the first body part may be receivable within the second body part.

Advantageously, one of the first body part and the second body part may include at least one projection and the other of the first body part and the second body part includes a projection-receiving hole for receiving the projection therethrough. Additionally, the second body part may include the at least one projection and the first body part includes the projection-receiving hole, the at least one projection may have an attachable flange at a free end thereof for securing the first body part to the second body part.

Preferably, the first body part may include a protruding rim which projects beyond the said at least one capsule-receiving chamber.

Optionally, the at least one capsule-receiving chamber may have a curved side wall and a base, the base having a lower opening to allow the capsule-breaching element to access the capsule.

Preferably, the capsule-breaching element may define a capsule-breaching-element hole through which content of the capsule is releasable.

Optionally, the capsule-breaching element may have a non-linear cutting surface. In particular, the cutting surface may be oriented in the direction of the actuation axis. Additionally, the cutting surface may define a planar cutting surface which may be parallel or substantially parallel to a plane of the lower opening of the said at least one capsule-receiving chamber.

Preferably, the capsule-breaching device may further comprise a sealing plate having an opening configured to correspond to the capsule-breaching-element hole.

Optionally, the capsule-breaching element may be conical or substantially conical.

Preferably, the openable closure element may include a stopper for removably closing an aperture of the discharge guide element. Additionally, the stopper may be connected to the first body part.

Advantageously, there may be a plurality of said capsule-receiving chambers and a plurality of said capsule-breaching elements, each capsule-receiving chamber corresponds with its respective capsule-breaching element.

According to a fourth aspect of the invention, there is provided a portable beverage-mixing system comprising a mixing body including a container for holding a liquid to be mixed with a powder dischargeable from at least one capsule; and a capsule-breaching device in accordance with the third aspect of the invention and which is releasably engagable with an end of the said container. Preferably, the capsule-breaching device may further comprise the openable closure element, the said discharge guide element of the capsule-breaching device, when the capsule-breaching device is engaged with the container, may be in flow communication with an interior of the container when the said closure element is in an open condition.

According to a fifth aspect of the invention, there is provided a detachable capsule-breaching head for a beverage-mixing device, the capsule-breaching head comprising: a capsule-container body having a first body part which is telescopically movable on an actuation axis relative to a second body part, at least one capsule-receiving chamber in one of the first and second body parts of the capsule-container body, a capsule-breaching element for breaching a capsule received in the capsule-receiving chamber, the capsule-breaching element being at the other of the said first and second body parts of the capsule-container body and movable relative to the capsule-receiving chamber on or parallel to the said actuation axis, a discharge guide element for guiding a powder released from a capsule by the capsule-breaching element, an openable closure element for sealingly closing the discharge guide element, and a removable access cover for closing an access opening of the capsule-receiving chamber.

According to a sixth aspect of the invention, there is provided a portable beverage-mixing device comprising a mixing body including a container for holding a liquid to be mixed with a powder dischargeable from at least one capsule; and a capsule-breaching head as claimed in any one of the preceding claims and which is releasably engagable with an end of the said container, the said guide element of the capsule-breaching head, when the capsule-breaching head is engaged with the container, being in flow communication with an interior of the container when the said closure element is in an open condition.

The invention will now be more particularly described, by way of example only, with reference to the accompanying drawings, in which:

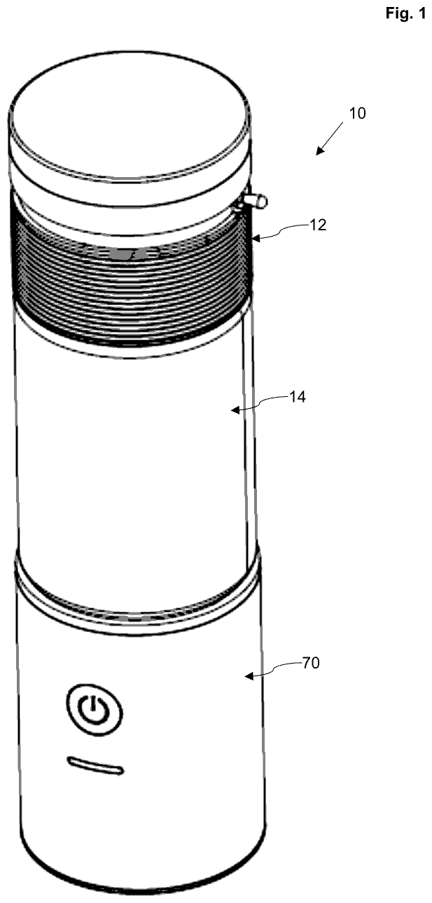

FIG. 1 shows a perspective view of a first embodiment of a portable beverage-mixing device in accordance with a second, fourth and sixth aspects of the invention, having a first embodiment of a detachable capsule-breaching head in accordance with a first, third and fifth aspect of the invention, and a first embodiment of a mixing body;

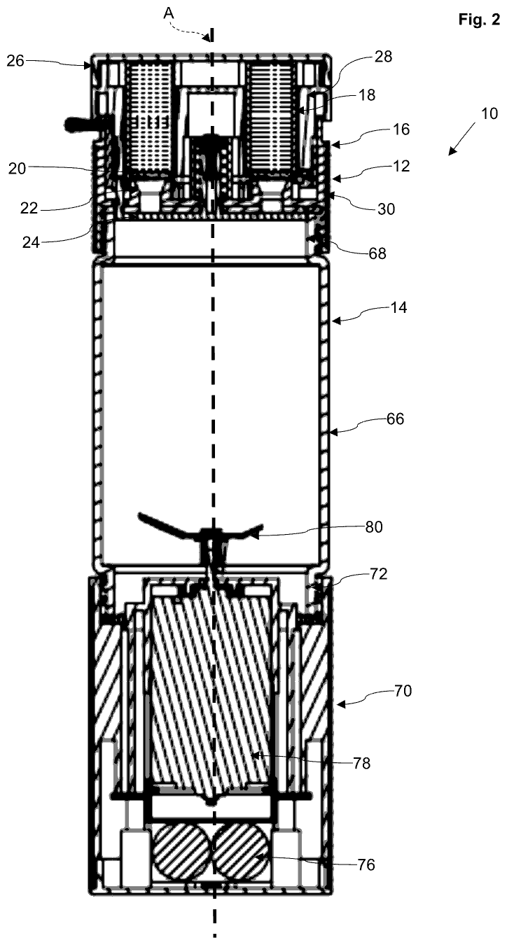

FIG. 2 shows a cross-sectional view of the portable beverage-mixing device of FIG. 1;

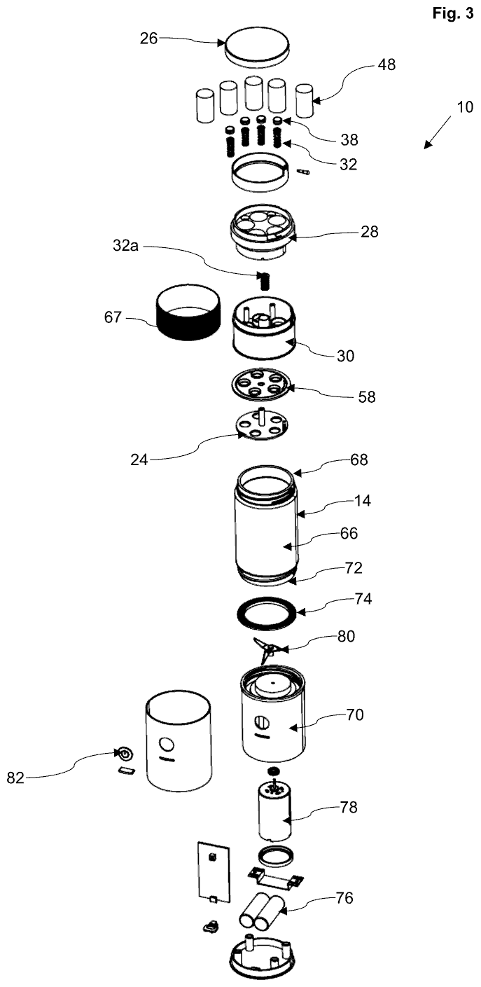

FIG. 3 shows an exploded view of the portable beverage-mixing device of FIG. 1;

FIG. 4 shows an exploded view of the detachable capsule-breaching head of FIG. 1;

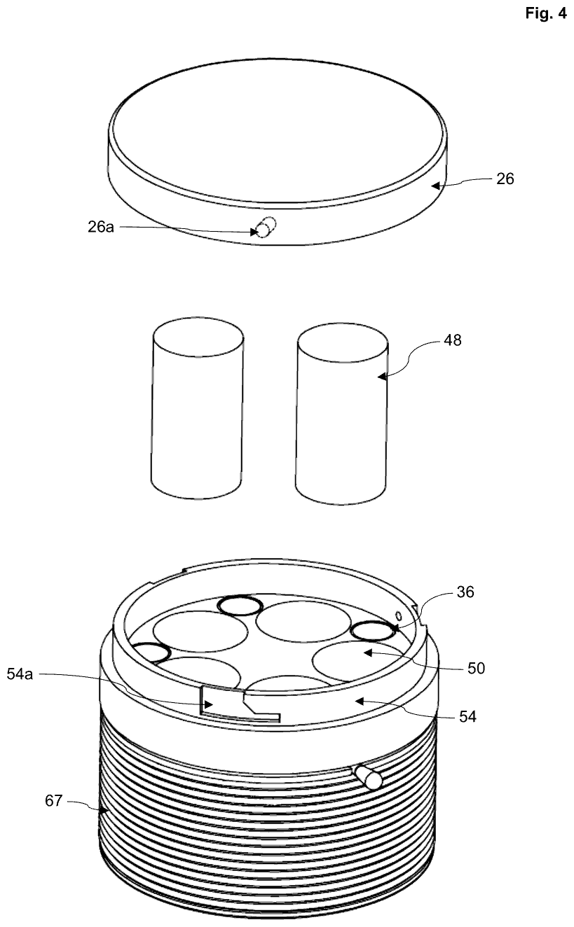

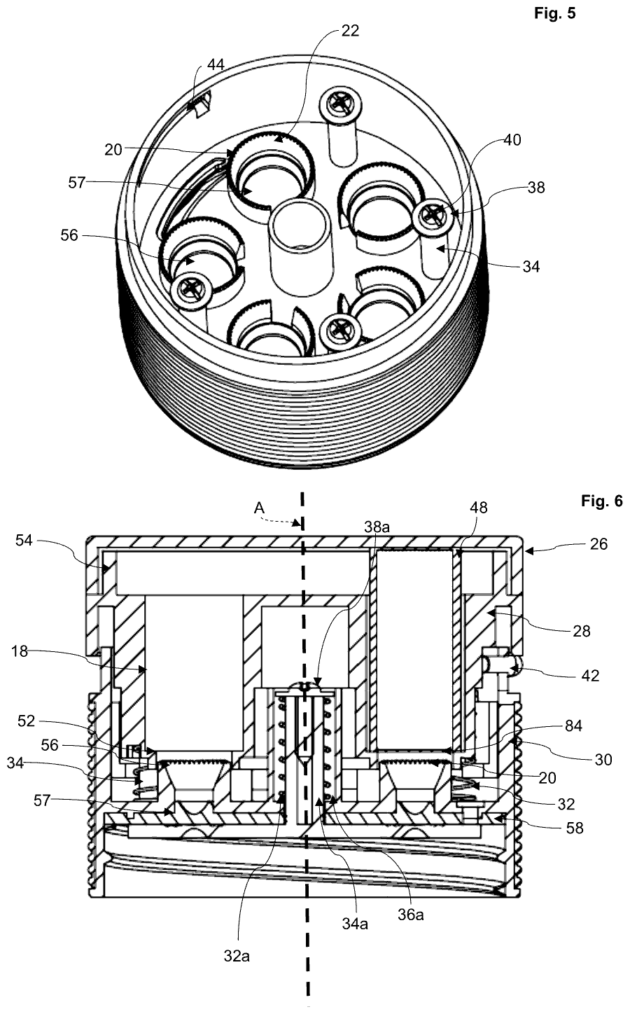

FIG. 5 shows a top perspective view of the detachable capsule-breaching head of FIG. 1, with a first body part and a removable access cover omitted;

FIG. 6 shows a cross-sectional view of the detachable capsule-breaching head of FIG. 1;

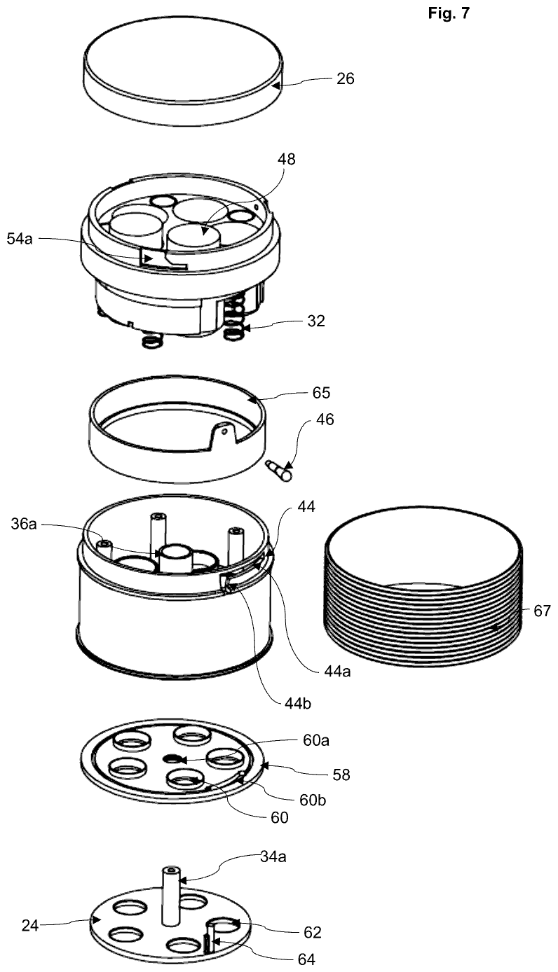

FIG. 7 shows an exploded perspective view of the detachable capsule-breaching head of FIG. 1;

FIG. 8 shows a cutaway perspective view of the detachable capsule-breaching head of FIG. 1 with an openable closure element in an open condition and the first body part and the removable access cover omitted;

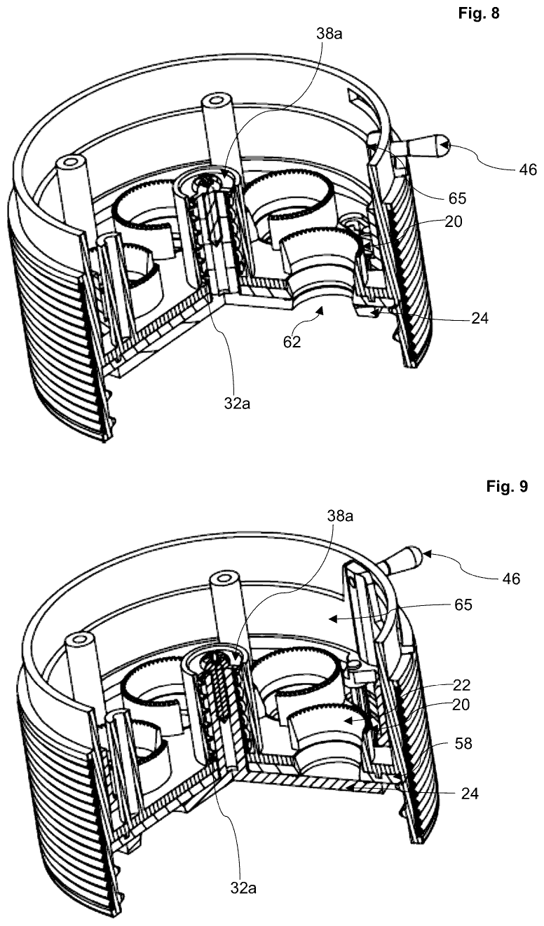

FIG. 9 shows the cutaway perspective view of FIG. 8 with the openable closure element in a closed condition and the first body part and the removable access cover omitted;

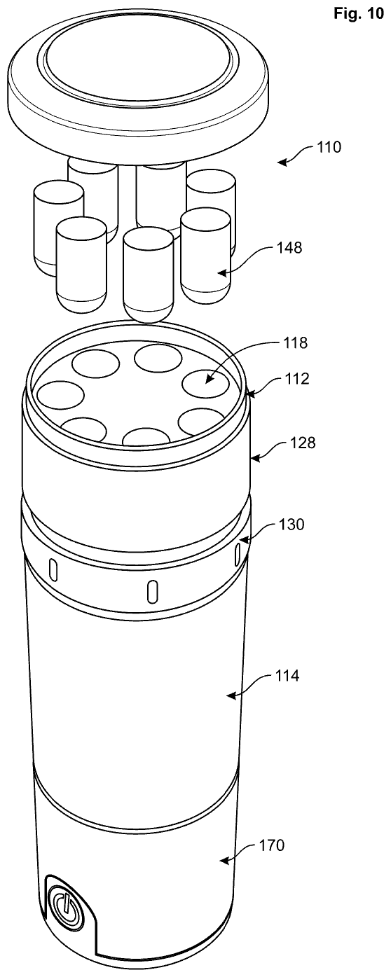

FIG. 10 shows a second embodiment of a portable beverage-mixing device in accordance with the second, fourth and sixth aspects of the invention having a second embodiment of a detachable capsule-breaching head in accordance with the first, third and fifth aspects of the invention, and a second embodiment of a mixing body;

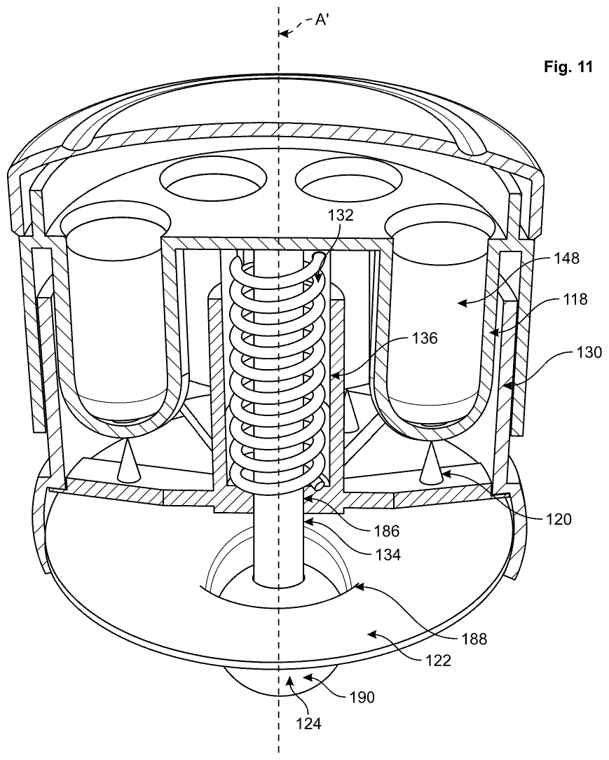

FIG. 11 shows a cutaway perspective view of the detachable capsule-breaching head of FIG. 10;

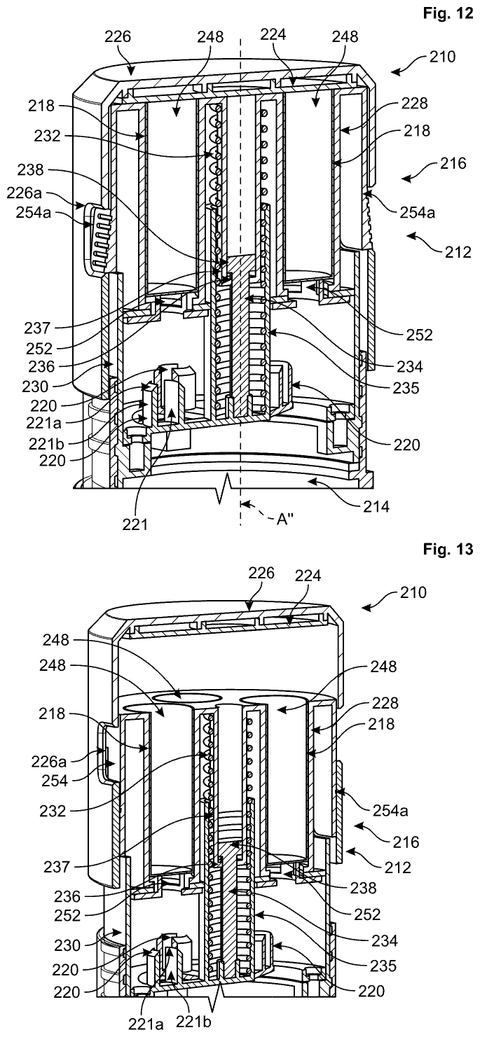

FIG. 12 shows a cross-sectional view of a third embodiment of a portable beverage-mixing device in accordance with the second, fourth and sixth aspects of the invention having a third embodiment of a detachable capsule-breaching head in accordance with the first, third and fifth aspects of the invention, a capsule provided in each capsule-receiving chamber, an upper end of each capsule being omitted for clarity, and a majority part of a mixing body omitted;

FIG. 13 shows the detachable capsule-breaching head of FIG. 12, the removable access cover being slid away from the capsule-container body;

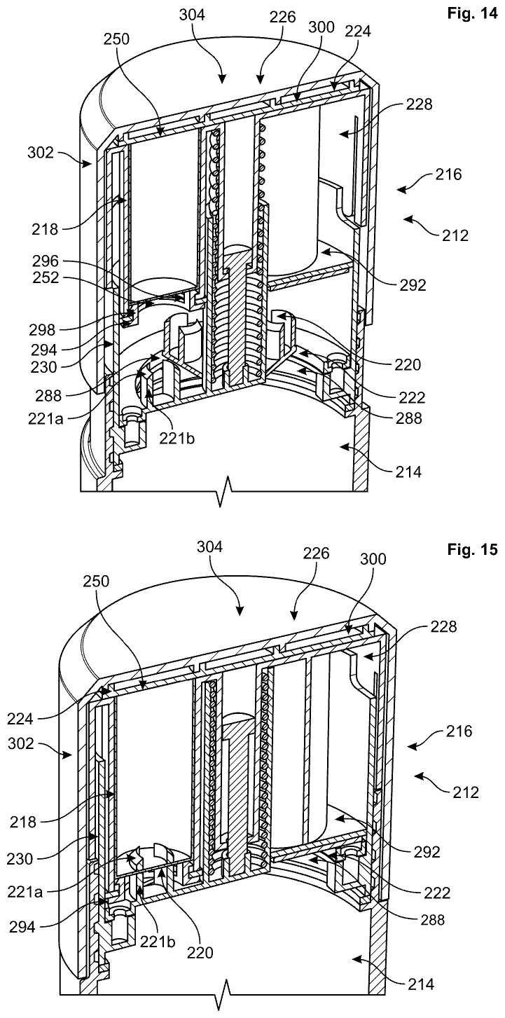

FIG. 14 shows a cross-sectional view of the detachable capsule-breaching head of FIG. 12, the first body part at a position furthest away from the second body part; and

FIG. 15 shows the detachable capsule-breaching head of FIG. 14, the first body part at a position closest to the second body part.

Referring firstly to FIGS. 1 to 3 there is shown a portable beverage-mixing device 10 comprising a detachable capsule-breaching head 12 and a mixing body 14. The detachable capsule-breaching head 12 comprises a capsule-container body 16, at least one capsule-receiving chamber 18, at least one capsule-breaching element 20, at least one discharge guide element 22 or discharge conduit, an openable closure element 24 and a removable access cover 26.

The capsule-container body 16 is cylindrical or substantially cylindrical in shape, although it will be appreciated that other shapes may be considered, such as cuboidal. The capsule-container body 16 has a first body part 28 and a second body part 30, the first body part 28 being telescopically movable on an actuation axis A relative to the second body part 30. At least part of the first body part 28 is preferably receivable within the second body part 30 and the first body part 28 is distal to the mixing body 14 as compared to the second body part 30. However, it will be appreciated that this may be inverted.

Referring in addition to FIGS. 4 to 9, the first body part 28 is preferably mounted to the second body part 30 so as to be movable towards and away from the second body part 30. More preferably the first body part 28 is mounted with at least one biasing element 32, such as a spring, so as to be biased away from the second body part 30. To allow for such mounting, the second body part 30 includes at least one upstanding projection 34, and the first body part 28 includes a projection-receiving hole 36 for receiving the upstanding projection 34 therethrough. The spring 32 is positioned around the upstanding projection 34, the spring 32 arranged so as to be compressible by a lower rim of the hole 36. The second body part 30 includes four such upstanding projections 34 and four such springs 32, and the first body part 28 includes four such holes 36, arranged to mount the first body part 28 to the second body part 30. However, it will be appreciated that any number of corresponding projections, springs and holes may be considered.

The first body part 28 is preferably secured to the second body part 30. Here this is achieved by each of the upstanding projections 34 having an attachable flange 38 or end cap at a free end of the upstanding projection 34. The flange 38 has a greater diameter than a shaft of the upstanding projection 34, and has a greater diameter than that of the hole 36 in first body part 28. To secure the first body part 28 to the second body part 30 the upstanding projections 34 of the second body part 30 are inserted through the corresponding holes 36 of first body part 28. One of the flanges 38 is then attached to the end of each upstanding projection 34, for example via a screw threaded fastener 40. The flange 38 is therefore engagable with an upper rim of the hole 36 to prevent the first body part 28 being removed from the second body part 30. It will be appreciated that such a securing mechanism may be used even if the first and second part are not biased relative to each other with a biasing element 32.

The capsule-breaching head 12 includes a releasable locking element 42 to selectively prevent and permit actuation of the capsule-breaching head 12 in the actuation axis A. In other words, the locking element 42 selectively prevents and permits movement of the first body part 28 towards the second body part 30 in the actuation axis A. The locking element 42 preferably comprises a detent, and includes, for example, an L-shaped slot 44 in the second body part 30. A first slot part 44a extends in a direction transverse or lateral to the actuation axis A, and a second slot part 44b extends in a direction in or parallel to the actuation axis A. A locking pin 46 is insertable through the slot 44. The locking pin 46 is engaged with the first body part 28 such that movement of the first body part 28 towards the second body part 30 requires the first body part 28 to drive the locking pin 46.

When the locking pin 46 is in the first slot part 44a, the locking pin 46 prevents or limits movement of the first body part 28 relative to the second body part 30 in the actuation direction. The locking pin 46 is movable or slidable to the second slot part 44b. When received in the second slot part 44b, the locking pin 46 is movable therealong in the actuation direction which allows the first body part 28 to be movable relative to the second body part 30 in the actuation direction.

There are here five capsule-receiving chambers 18 or compartments, each for receiving one capsule 48, cartridge or container of powder. However, any number of chambers may be considered, including only one chamber 18. The capsules 48 are preferably cylindrical or substantially cylindrical and thus each of the capsule-receiving chambers 18 are also cylindrical and have a cross-section which is similar or identical to that of the capsules 48. For example, each chamber 18 has a diameter which is similar to, identical to or slightly greater than the diameter of the capsule 48. The or each said capsule-receiving chamber 18 has a uniform or substantially uniform lateral extent along at least a majority of the longitudinal extent thereof. The or each said capsule-receiving chamber 18 has a longitudinal axis which is on or in parallel to the actuation axis A.

The chambers 18 are preferably equiangularly spaced apart around a central axis of the capsule-breaching head 12. Given there are five chambers 18, each chamber 18 may be spaced apart from an adjacent chamber 18 by 72 degrees. However, it will be appreciated that non-equiangular spacing may be considered. Each chamber 18 has a capsule access opening 50 for providing access for one capsule 48 to be inserted therein.

Each of the chambers 18 are in the first body part 28 and each may be considered to be a recess or hole in the first body part 28. However, each may in fact be in the second body part 30. The chambers 18 each have a curved side wall and a base, the base being for supporting the capsule 48 thereon. The base has a lower opening 52 therein to allow the capsule-breaching element 20 to access the capsule 48, and to allow powder to flow from the capsule 48 into the discharge guide element 22. The base may thus be considered to be a ledge around the side wall of the chamber 18. Whilst each of the chambers 18 are here shown to be identical or substantially identical, it will be appreciated that the chambers 18 may be of differing sizes or shapes to accommodate differently sized or shaped capsules 48.

The first body part 28 includes a protruding rim 54 which projects above and/or beyond the chambers 18. The rim provides a surface to which the removable access cover 26 may engage or be mounted, as well as providing or defining a space to accommodate an extent of the capsule 48 which may protrude from the chamber 18.

There is preferably one capsule-breaching element 20 for each chamber 18, each capsule-breaching element 20 being positioned so as to be received through the lower opening 52 in the base of the chamber 18. The capsule-breaching elements 20 are preferably on the second body part 30 so that relative movement between the first body part 28, which in use receives the capsules 48, and the second body part 30 may cause the capsule-breaching element 20 to breach the capsule 48. Thus, the chamber 18 is on one of the first and second body parts 28, 30 and the capsule-breaching element 20 is on the other of the first and second body parts 28, 30. In this way, relative movement on or parallel to the actuation axis A between the capsule-breaching element 20 and the capsule-receiving chamber 18 is possible. The capsule-breaching elements 20 have a corresponding arrangement to the chambers 18. Whilst the capsule-breaching elements 20 are termed as such, it will be appreciated that they may also be termed cutting, slicing or piercing elements and may act on the capsule in a corresponding manner.

The breaching element 20 is preferably a flap-creation device, so that when actuated towards the capsule 48 it creates a cut part of the way around a portion of the capsule 48. The part of the portion of the capsule 48 which is not cut forms a hinge such that a flap is created. To this extent, the breaching element 20 may be a cutting element which has a non-linear cutting surface and the cutting surface faces the actuation axis A. For example, here the breaching element 20 defines a rim of an arcuate discontinuous wall. It will be appreciated that facetted shapes may be considered for the discontinuous wall. The cutting surface of the breaching element 20 defines a planar cutting surface which is parallel or substantially parallel to the plane of the lower opening of the chamber 18. However, the plane of the cutting surface may be at an angle to the plane of the lower opening of the chamber 18 to assist with breaching.

The capsule-breaching element 20 preferably defines a capsule-breaching-element hole 56 through which powder may fall once released from the capsule 48.

Preferably, the capsule-breaching element 20 includes a plurality of piercing elements which upstand on or parallel to the actuation axis A. Each piercing element is a pointed tooth, and therefore may have a triangular cross-section.

The discharge guide element 22 comprises a channel, conduit, tube, hole or baffle. There is a discharge guide element 22 at, adjacent to and/or under each capsule-breaching element 20 to direct powder which is released from the capsule 48 once the capsule 48 is breached. The discharge guide element 22 includes a discontinuous truncated frusto-conical surface which forms at least part of an interior surface of the arcuate discontinuous wall of the capsule-breaching element 20. Here the channel is formed at least in part by the second body part 30 and comprises an aperture 57 in a base thereof.

The capsule-breaching head 12 preferably further includes a sealing plate 58 which includes a plurality of openings 60, each opening 60 configured to correspond to the capsule-breaching-element hole 56. Each opening 60 is preferably aligned with the channel and/or may form part of the discharge guide element 22. The sealing plate 58 prevents or limits splash-back from the mixing body 14 from impacting on the second body part 30.

The openable closure element 24 is for sealingly closing the discharge guide element 22, opening in the sealing plate 58 and/or discharge guide element 22. Thus, the closure element 24 is also effectively adapted for sealingly closing, albeit indirectly, the capsule-receiving chamber 18 in the first body part 28, which is upstream of or above the sealing plate 58 and discharge guide element 22 in or adjacent to the second body part 30. The openable closure element 24 has at least one, and preferably a plurality of, powder-access apertures 62 therethrough. A body of the openable closure element 24 is positionable to occlude or seal the discharge guide elements 22 and/or the capsule-breaching-element holes 56. The number and arrangement of the powder-access apertures 62 corresponds to the number of capsule-receiving chambers 18 and therefore here there are five equiangularly spaced apart powder-access apertures 62. The spacing between two powder-access apertures 62 is such that an intervening portion of the body of the openable closure element 24 can occlude one discharge guide element 22 and/or one capsule-breaching-element hole 56.

Referring in particular to FIGS. 7 to 9, the openable closure element 24 includes a connecting element 64, which comprises an upstanding projection, to connect the openable closure element 24 with the locking pin 46 of the locking element 42. The upstanding projection preferably connects to an intermediate element 65, which may be a sleeve, which connects to the locking pin 46. When the locking pin 46 is moved along the first slot part 44a this moves the openable closure element 24 via the connecting element 64. Since here the first slot part 44a is arranged in a circumferential direction around the second body part 30, movement of the locking pin 46 along the first slot part 44a rotates the openable closure element 24. As such, the openable closure element 24 is rotated so that the powder-access apertures 62 are moved from being misaligned with the discharge guide elements 22 and/or the capsule-breaching-element holes 56, to being aligned with the discharge guide elements 22 and/or the capsule-breaching-element holes 56. In this way, when the locking pin 46 is in the second slot part 44b, the openable closure element 24 is in the open condition, as shown in FIG. 8, so that powder may flow through the powder-access apertures 62, and when the locking pin 46 is not in the second slot part 44b, the openable closure element 24 is in the closed condition, as shown in FIG. 9, so that powder may not flow through the powder-access apertures 62.

Since the openable closure element 24 is connected to the locking pin 46, the openable closure element 24 is required to be movable in a direction in or parallel with the actuation direction. To this extent, the openable closure element 24 includes a further upstanding projection 34a which is receivable in a corresponding hole 36a in the second body part 30. A biasing element 32a, such as a spring, is positioned within the hole 36a and a flange 38a is attachable to the end of the upstanding projection 34a. The flange 38a compresses the spring 32a against a rim of the hole 36a. In this way the openable closure element 24 is spring biased relative to the second body part 30 in a similar way as the first body part 28.

The sealing plate 58 has an aperture 60a to receive the upstanding projection 34a and an aperture 60b to receive the connecting element 64 of the openable closure element 24. The aperture 60b to receive the connecting element 64 is a curvate slot to accommodate the movement of the connecting element 64.

The removable access cover 26 is for closing the access openings 50 of the capsule-receiving chambers 18. Here the removable access cover 26 is a lid which is positionable on the first body part 28. The first body part 28 includes an exterior ledge for receiving the removable access cover 26 thereon. The removable access cover 26 may be lockable to the first body part 28, for example the removable access cover 26 may have an inward protrusion 26a receivable within a detent 54a, groove or slot of the protruding rim 54 of the first body part 28. Rotating the removeable access cover 26 may lock the protrusion 26a within the detent 54a. Counter-rotation of the removeable access cover 26 may allow the protrusion 26a to be slid upwards and out of the detent 54a.

The second body part 30 preferably includes a textured surface which may improve grip when actuating the capsule-breaching head. The textured surface is here provided by a sleeve element 67.

Referring again to FIGS. 1 to 3, the mixing body 14 is releasably engagable with the capsule-breaching head 12, and in particular is releasably engagable with the second body part 30 of the capsule-breaching head 12. Releasable engagement may be achieved by mutually interengagable screw threads. For example, the mixing body 14 may comprise a first screw thread at an opening thereof, and the second body part 30 may comprise a second screw thread which is interengagable with the first screw thread. The mixing body 14 includes a container 66 which has an opening at a first end 68. The capsule-breaching head 12 is releasably engagable at or adjacent to said first end 68. In this way, the discharge conduit of the capsule-breaching head 12 is in flow communication with an interior of the container 66 when the closure element 24 is in the open condition. The container 66 and/or mixing body 14 is preferably substantially cylindrical although other shapes for the container may be considered.

The removable access cover 26 is preferably also releasably engagable with the first end 68 of the container 66. For example, the removable access cover 26 may comprise a third screw thread which is similar or identical to the second screw thread so that it is interengagable with the first screw thread. In this way, the removable access cover 26 may be utilised to close the opening of the container 66.

The beverage mixing device further comprise a mixer body 70 which is engagable with a second end 72 of said container 66 which is opposite the first said end 68. It will be appreciated that the mixer body 70 may be separable from the container 66, for example to assist with cleaning the container 66, or may be integrally formed therewith. The beverage mixing device may include a seal 74 for assisting with sealing the container 66 with the mixer body 70.

The mixer body 70 houses a power source 76, an electric motor 78 which is energisable by the power source 76, and at least one blending element 80 for blending the contents in the container 66 and which is drivable by the electric motor 78.

The power source 76 here comprises at least one battery, and there are here two rechargeable batteries. The batteries may be recharged via a charging port, such as a Universal Serial Bus charging port. Whilst a rechargeable battery is suggested, it will be appreciated that non-rechargeable batteries may also be used. Alternatively, the mixer body may not comprise a power source and the beverage mixing device may instead comprise a plug for connection to an external power supply. In this instance the beverage mixing device may not necessarily be considered to be portable.

The blending element 80 may for example comprise a plurality of cutting elements and is rotatably mounted to the mixer body 70 so that it is receivable within the container 66. The blending element 80 is connected to the motor so that the blending element 80 is rotatable by the motor. The mixer body 70 also includes a switch 82, such as a button, for operating the electric motor 78.

In use, the rechargeable batteries 76 are suitably charged and the mixing body 14 is attached to the mixer body 70. The second end 72 of the container 66 preferably comprises an opening to receive the blending element 80 therethrough. A liquid, such as water, is inserted into the container 66. The capsule-breaching head 12 is then attached to the container 66 by interengaging the first and second screw threads.

At least one capsule 48 is inserted into one of the capsule-receiving chambers 18, and multiple capsules 48 may each be inserted into respective capsule-receiving chambers 18 if desired. The chamber 18 and the capsule 48 are preferably sized so that the capsule 48 is longer than the chamber 18 so that each capsule 48 protrudes from chamber 18. This allows for easy removal of the capsule 48 from the chamber 18. Each capsule 48 preferably comprises an access wall 84 which is at least in part formed from a flexible material, such as a polymer film or a metal foil. The access wall 84 is preferably an end, flat or bottom surface of the capsule 48, for example. The access wall 84 may be thinner than other walls of the capsule 48 The capsule 48 is inserted into the capsule-receiving chambers 18 so that the access wall 84 is facing downwards and/or towards the breaching element 20. The removable access cover 26 is then attached to the first body part 28 of the capsule-breaching head 12. The capsule 48, chamber 18 and the protruding rim 54 of the first body part 28 are preferably configured so that capsule 48 terminates at or adjacent to an in use upper end of the rim 54. In this way the removable access cover 26 may in use engage a top of the capsule 48 which allows for the capsule 48 to be engaged and actuated into the breaching element 20.

The capsule 48 preferably contains a powder, which is more preferably a nutritional powder and may more preferably comprise dried fruit, such as freeze-dried fruit. However, it will be appreciated that other nutritional powders may be considered, such as protein powders. A powder may be considered to be a solid in particulate form. Whilst the capsule-breaching head is for capsules containing powder, it will be appreciated that the capsule-breaching head may be used with capsules containing liquid or gel.

The locking pin 46 is moved from the first slot part 44a to the second slot part 44b, so that the releasable locking element 42 adopts an unlocked condition which permits movement of the first body part 28 to the second body part 30. This also moves the openable closure element 24 to the open condition.

The first body part 28 is then moved, for example being manually pushed, towards the second body part 30 in the actuation direction. Such movement causes the springs 32 32a to compress, as well as moving the openable closure element 24 away from the second body part 30.

The movement or actuation of the first body part 28 towards the second body part 30 causes the capsule 48 to move towards the breaching element 20. For example, the removable access cover 26 is manually pushed downwards which directly forces the first body part 28 and/or capsule 48. The capsule 48 is therefore forced directly into the breaching element 20. The piercing elements of the breaching element 20 perforate, break or cut at least part of the access wall 84. Since the breaching element 20 preferably comprises the flap-creation device, a non-straight cut is made in the access wall 84. For example, here an arcuate discontinuous cut, which is preferably near circular, is made in the access wall 84. Since the cut is discontinuous, preferably no part or portion of the access wall 84 is completely disconnected from the remainder of the access wall 84. A hinge portion of the access wall 84 is formed by an uncut portion of the access wall 84, or in other words, a hinge portion of the access wall 84 is formed by a portion of the access wall 84 which is between two ends of the breaching element 20. A flap portion of the access wall 84 is defined by the area between or surrounded by the hinge portion and the cut made by the breaching element 20.

Since the access wall 84, or at least the hinge portion, comprises flexible material, the flap portion pivots outwardly about the hinge portion to create an opening in the capsule 48. The powder which is contained within the capsule 48 is thus discharged or released from the capsule 48 and may fall under gravity from the capsule 48. The first body part 28 can be moved away from the second body part 30, for example by the springs 32, 32a so that the breaching element 20 is withdrawn from the capsule 48. This may assist with permitting the powder to exit the capsule 48 and/or permitting the flap portion to pivot outwardly.

The movement of the first body part 28 away from the second body part 30 exposes the upper end of the capsule 48 from the chamber 18 so that, once the access cover 26 is removed, the or each capsule 48 can be easily manually accessed and removed from the container 66.

The powder is directed by the discharge guide element 22 towards the container 66. The discharge guide element 22 is at least in part frusto-conical, or sloped, and thus funnels the powder towards the container 66. The powder then passes through the openings 60, 62 in the sealing plate 58 and the openable closure element 24 and into the container 66 of the mixing body 14 through the opening of the container 66.

The locking pin 46 can then be moved out of the second slot 44 part and along the first slot 44 part to close or seal the discharge guide elements 22 with the openable closure element 24, as well as preventing or limiting the first body part 28 from unintentionally moving along the actuation axis A.

The button 82 may then be pressed so that the power source 76 energises the electric motor 78 which drives the blending element 80. The button may be required to be continuously pressed to drive the blending element 80, alternatively the beverage-mixing device may comprise a timing element and pressing the button may drive the blending element 80 for a predetermined recommended mixing duration. The blending element 80 mixes the powder with the liquid to form a powder-based beverage which preferably has a uniform or substantially uniform consistency.

The capsule-breaching head 12 can then be removed from the container 66 which allows for a user to drink the beverage from the opening of the container 66. Alternatively, the user may attach the openable closure element 24 to the container 66 so as to close the opening of the container 66 and preserve the beverage for later consumption.

After consumption of the beverage, the mixer body 70 may be detached from the mixing body 14 to allow for efficient cleaning of the components.

Referring to FIGS. 10 and 11, a second embodiment of a portable beverage-mixing device 110 is shown. The second embodiment is similar to the first embodiment and similar or identical referencing numerals are used with 100 added.

A first body part 128 of a capsule-breaching head 112 of the second embodiment has seven equiangularly spaced apart capsule-receiving chambers 118, and each chamber 118 is shaped to correspond to a capsule 148 having a rounded lower portion. However, it will be appreciated that chambers similar or identical to that of the first embodiment may be utilised. Each chamber 118 has a hole or opening in a lower surface thereof to receive a capsule-breaching element 120 therethrough.

The first body part 128 includes a shaft 134 or projection which is receivable within a recess or hole 136 of a second body part 130. The first body part 128 is at least in part telescopically movable on an actuation axis A′ within the second body part 130. A spring 132 or other biasing element surrounds the shaft 134 so as to bias the first body part 128 away from the second body part 130. The recess 136 has a hole 186 in a bottom surface thereof to permit the shaft 134 to extend or protrude beyond the recess 136. It will be appreciated that further biasing elements may be utilised, similar to the first embodiment.

There are preferably an equivalent number of capsule-breaching elements 120 as there are chambers 118. In other words, there are seven capsule-breaching elements 120. Each capsule-breaching element 120 of the second embodiment preferably comprises a single pointed element, for example each capsule-breaching element 120 is conical or substantially conical.

There is preferably a single discharge guide element 122 communicable with and/or below all of the chambers 118. The discharge guide element 122 comprises a surface which slopes towards a central aperture 188, and may be considered to be frusto conical in shape.

An openable closure element 124 is provided, comprising a stopper 190 which may be moved so as to open and close or occlude the central aperture 188 of the single discharge guide element 122. Here the stopper 190 is spherical or ball shaped and is connected to the first body part 128, preferably via the shaft 134. The openable closure element 124 is configured so that the stopper 190 is at or adjacent to a distal side of the central aperture 188 from the chambers 118. In a closed condition, the stopper 190 is at the central aperture 188 so that the central aperture 188 is blocked or occluded. When the first body part 128 is moved towards the second body part 30 in the actuation axis A′, the stopper 190 is moved away from the central aperture 188 so that the central aperture 188 is opened.

A mixer body 170 and a mixing body 114 of the second embodiment is similar or identical to the first embodiment.

In use, the mixer body 170 and mixing body 114 are attached to each other in a similar or identical way as previously described, the mixing body 114 is at least part filled with liquid, and the mixing body 114 is attached to the capsule-breaching head 112, also in a similar or identical way as previously described. One or more capsules 148 are inserted into one or more respective chambers 118.

The first body part 128 is moved or actuated towards the second body part 130 in an actuation direction. Each capsule 148 is perforated, breached or cut by a corresponding capsule-breaching element 120 to form an opening. This may allow for the powder to be released or discharged from each capsule 148. However, it will be appreciated that the first body part 128 part may be required to be moved away from the second body part 130 in case each capsule-breaching element 120 blocks each corresponding opening. Once the powder is discharged from each capsule 148, it will be appreciated that the first body part 128 may be required to be moved towards the second body part 130 again so as to move the stopper 190 away from the central aperture 188 and so open the openable closure element 124. This allows for powder to fall under gravity through to the mixing body 114. The mixer and mixing body 170, 114 may then be used to mix the powder and liquid into a beverage in a similar or identical way as previously described.

Referring to FIGS. 12 to 15, a third embodiment of a portable beverage-mixing device 210 is shown. The third embodiment is similar to the first or second embodiment and similar or identical referencing numerals are used with 200 added. Features in the third embodiment that are the same or that work in the same way as those in the first or second embodiments are not described again in detail for conciseness.

A first body part 228 of a capsule-container body 216 of a capsule-breaching head 212 of the third embodiment has five equiangularly spaced apart capsule-receiving chambers 218, and similar to the first embodiment each chamber 218 is shaped to correspond to a capsule 248 having a flat or planar lower portion. However, it will be appreciated that chambers similar to or identical to that of the second embodiment may be utilised. Each chamber 218 has a lower hole or lower opening 252 in a lower surface or base thereof to receive a capsule-breaching element 220 therethrough.

The first body part 228 is preferably mounted to a second body part 230 of the capsule-container body 216, and are preferably at least in part telescopically movable on an actuation axis (A″) within the second body part 230. The second body part 230 preferably includes an upstanding projection 234, and the first body part 228 preferably includes a projection-receiving hole 236 at a distal end of a projection-receiving shaft 237 for receiving the upstanding projection 234 therethrough. Similar to the first embodiment, a flange 238 is preferably provided at the end of the upstanding projection 234 to engage with an upper rim of the projection-receiving hole 236 to prevent the first body part 228 from being removed from the second body part 230. The projection-receiving shaft 237 of first body part 228 is preferably mounted with a biasing element 232, such as a spring, around its outer surface so as to be biased away from the second body part 230. The second body part 230 is preferably further provided with a biasing-element retaining means 235, such as a hollow upstanding projection having an open distal end, for receiving at least a portion of the biasing element 232 and the upstanding projection 234 therein. In use, the projection-receiving shaft 237 of the first body part 228 is movable on the actuation axis (A″) and slidably receivable in within the biasing-element retaining means 235 of the second body part 230.

The securing mechanism as described above is preferably provided at or adjacent to the actuation axis (A″) of the capsule-container body 216. However, it will be appreciated that the securing mechanism need not be provided at or adjacent to the centre and additional biasing-element retaining means, springs, projection-receiving shafts and/or upstanding projections may be provided.

There is preferably an equivalent number of capsule-breaching elements 220 as there are chambers 218. In other words, there are five capsule-breaching elements 220. Each capsule-breaching element 220 in the third embodiment is preferably on the second body part 230, more preferably extending outwardly from a base of the second body part 230 so as to be received through the lower opening 252 of the capsule-receiving chamber 218. Preferably, each capsule-breaching element 220 is a puncture-creation device so that when actuated towards the capsule 248 it creates one or more holes at the base of the capsule 248 through which powder inside the capsule 248 may be released and fluid in the mixing body 214 may enter the capsule 248 to mix with the powder remained therein. The puncture-creation device is preferably defined by a plurality of piercing elements which upstand on or is parallel to the actuation axis (A″).

The piercing elements define a rim of an arcuate discontinuous wall, the rim being the cutting surface which is planar and is parallel or substantially parallel to the plane of the lower opening 252 of the capsule-receiving chamber 218. Preferably, each piercing element is a pointed tooth, and therefore may have a triangular cross-section. In the third embodiment, the rim is provided in two spaced-apart and opposing rim parts 221a, and similarly the arcuate discontinuous wall is provided in two spaced-apart and opposing arcuate wall-parts 221b. It will be appreciated that although two arcuate wall-parts are provided, more or fewer number of angularly spaced apart wall-parts may be provided.

In the third embodiment, a discharge guide element 222 is provided and preferably comprises five angularly spaced apart apertures 288 which extends through the base of the second body part 230. Additionally, the lower opening 252 of the base of the capsule-receiving chamber 218 may also form part of the discharge guide element 222, in form of a channel.

The capsule-breaching head 212 preferably further includes a first sealing plate 292 which includes a plurality of openings, each opening configured to correspond to or aligned with the lower opening 252 of the capsule-receiving chamber 218. Each opening may thus form part of the discharge guide element 222. The first sealing plate 292 preferably has a perimeter edge sized to abut against an interior surface of the second body part 230.

The capsule-breaching head 212 preferably further includes a first-sealing-plate retainer plate 294 engaged with the base of the capsule-receiving chamber 218, so as to retain the first sealing plate 292 therebetween. The first-sealing-plate retainer plate 294 preferably includes a plurality of openings 296, each configured to correspond to the lower opening 252 of the capsule-receiving chamber 218. Each opening 296 may thus also form part of the discharge guide element 222. One or more upstanding retainer arms 298 is provided at or adjacent to each opening 296 on the first-sealing-plate retainer plate 294 for attaching the plate 294 to the base of the capsule-receiving chamber 218. The first sealing plate 292 prevents or limits powder or liquid in the second body part 230 from leaking or seeping into the first body part 228 via any gaps between the capsule-receiving chamber 218 and the first-sealing-plate retainer plate 294 or the second body part 230 or via any gaps between the first body part 228 and the second body part 230.

The openable closure element 224 of the third embodiment of the capsule-breaching head 212 is for sealingly closing the capsule-receiving chamber 218, preferably an access opening 250 of each capsule-receiving chamber 218. Thus, the closure element 224 is also effectively adapted for sealing closing, albeit indirectly, the discharge guide element 222, opening in the first sealing plate 292 and/or opening in the first-sealing-plate retainer plate 294.

The closure element 224 is preferably removably engageable with the first body part 228. In particular, the closure element 224 is preferably positioned at or adjacent to a removable access cover 226. For example, the closure element 224 preferably includes a second sealing plate 300 provided on or attached to an interior surface of a top end of the removable access cover 226. The second sealing plate 300 is preferably sized to occlude or seal the access openings 250 of the capsule-receiving chambers 218. The closure element 224 prevents or limits powder or liquid in the capsule-receiving chamber 218 in the first body part 228 from leaking or seeping into the removable access cover 226 via the access openings 250 of the capsule-receiving chambers 218.

It will be appreciated that multiple second sealing plates may be provided, each sized to correspond to each access opening.

A releasable locking element is preferably provided which, when the removable access cover 226 is engaged with the capsule-container body 216 to close the access openings 252 of the capsule-receiving chambers 218 and the closure element 224 is engaged with the first body part 228 to close the capsule-receiving chambers 218 and the discharge guide element 232, can prevent or limit relative movement of the first and second body parts 228, 230. The releasable locking element in the third embodiment of the capsule-breaching head 212 which is provided in one of the first and second body parts 228, 230 and adapted to engage with a corresponding locking part provided in the other of the first and second body part 228, 230 may be identical or similar to the releasable locking element 42 and the locking pin 46 in the first embodiment of the capsule-breaching head 12.

Here, the removable access cover 226 is a lid having a perimeter wall 302 extending from a closed top end 304, the perimeter wall 302 defining a space for receiving at least a portion of the first and second body parts 228, 230. The removable access cover 226 may be lockable to the first body part 228, for example the removable access cover 226 may have a slot 226a in its perimeter wall 302 for receiving an outward protrusion 254a of a rim 254 of the first body part 228. The outward protrusion 254a preferably extends outwardly and downwardly along the actuation axis (A″).

When the outward protrusion 254a is in the slot 226a, the removable access cover 226 is locked against the first body part 228. To release the removable access cover 226 from the first body part 228, pressure can be applied on the outward protrusion 254a towards the capsule-receiving chamber 218 to release the protrusion 254a from the slot 226a such that the removable access cover 226 may slide upwards and away from the first body part 228.

The capsule-breaching head 212 of the third embodiment preferably has two spaced apart and opposing outward protrusion 254a and corresponding slots 226a. It will however be appreciated that fewer or more than this number may be provided.

A mixer body and a mixing body 214 of the third embodiment is similar or identical to the first or second embodiment.

In use, the mixer body and mixing body 214 are attached to each other in a similar or identical way as previously described, the mixing body 214 is at least part filled with liquid, and the mixing body 214 is attached to the capsule-breaching head 212, also in a similar or identical way as previously described. One or more capsules 248 are inserted into one or more respective chambers 218. The removable access cover 226 is slid onto the first body part 228 until each outward protrusion 254a is engaged in its corresponding slot 226a to lock the removable access cover 226 against first body part 228.

The first body part 228 is moved or actuated from the position shown in FIG. 14 towards the second body part 230 in an actuation direction and to the position shown in FIG. 15. Each capsule 248 is perforated, breached or cut by a corresponding capsule-breaching element 220 to form two openings. This may allow the powder to be released or discharged from each capsule 248. However, it will be appreciated that the first body part 228 part may be required to be moved away from the second body part 230 in case each capsule-breaching element 220 blocks corresponding openings.

This allows powder discharged from each capsule 248 to fall under gravity through the apertures 288 of the discharge guide element 232 and to the mixing body 214. The mixer and mixing body 214 may then be used to mix the powder and liquid into a beverage. Even if the powder has not been completely discharged from each capsule 248, during mixing, splash-back from the mixing body 214 enters each capsule 248 through the apertures 288 of the discharge guide element 232 and the openings in each capsule 248 to entrain or mix with any remaining powder in each capsule. The liquid falls under gravity again back to the mixing body 214. This encourages thorough and complete mixing of the powder and the liquid. The openable closure element 224 and the first sealing plate 292 ensures that even though liquid can enter the capsules 248 in the capsule-receiving chambers 218, the liquid does not leak out of the capsule-container body 216 and to the removable access cover 226.

Whilst a mixer body with an electric motor and power source is described, it will be appreciated that this may not be required and the powder and the liquid may be mixed without the blender.

For example, the mixing body may be shaken or mixed, and a mixer ball or blender ball may be included in the container to assist with mixing.

It will be appreciated that although the first body part is described as being telescopically movable on an actuation axis relative to the second body part, it will be appreciated that this may not be the case. For example, the first body part may be rotatable, twistable, or movable with respect to the second body part. Such an arrangement might be utilised to allow for the capsules to be cut with a rotation or twisting action so as to slice or cut the end portion of the capsule. In this case, a capsule-breaching element may be arranged so that it has a cutting surface facing a lateral or sideways direction. The capsule-receiving chamber may have an aperture or slot in a lateral surface thereof to permit the capsule-breaching element to access a side surface of the capsule, for example a curved surface of the cylindrical capsule. The movement or rotation of the first body part relative to the second body part may therefore result in the lower end portion of the capsule preferably being cut or sliced part way through. To prevent the lower end portion of the capsule being cut entirely through, the capsule-breaching head may include a stop. The part-way through cut is preferable as this may result in the creation of a flap. However, it will be appreciated that the lower end portion of the capsule may be cut entirely through.

It will also be appreciated that the capsule-container body need not comprise a first body part and a second body part, as long as the at least one capsule-receiving chamber is provided in the capsule-container body and the capsule-breaching element is movable to breach the capsule received in the capsule-receiving chamber, the discharge guide element guiding the powder released from the capsule.

It will be appreciated that the access cover, the discharge guide element, and the openable closure element may not be included. Additionally, it will be appreciated that the access cover may not necessarily be separable from the first body part, for example being pivotable therewith. It will be appreciated that the access cover may not be a complete cover and may simply be a restraining means for restraining the movement of the capsules away from the breaching element.

It is therefore possible to provide a detachable capsule-breaching head for a beverage mixing device. The detachable capsule-breaching head has two parts or portions which are movable towards each other. This allows for the capsule to be stamped by a breaching element to create one or more opening without losing part of the capsule. In one particular embodiment, the detachable capsule-breaching head creates a flap. Therefore, a large opening can be created in the capsule to allow for powder to flow therethrough, without a part of the capsule falling with the powder into a mixing body of the beverage mixing device. It will be appreciated that the capsules may be single-use disposable capsules, or may be reusable non-disposable capsules.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A detachable capsule-breaching head comprising:
a capsule-container body having a first body part to telescopically move on an actuation axis relative to a second body part,
at least one capsule-receiving chamber in one of the first and second body parts of the capsule-container body,
a capsule-breaching element to breach a capsule received in the capsule-receiving chamber,
wherein the capsule-breaching element is at the other of the said first and second body parts of the capsule-container body and moves relative to the capsule-receiving chamber on or parallel to the said actuation axis,
a discharge guide element which guides a powder released from a capsule by the capsule-breaching element,
an openable closure element which sealingly closes the discharge guide element, and
a removable access cover which closes an access opening of the capsule-receiving chamber.

2. The removable capsule-breaching head as claimed in claim 1, wherein the capsule-breaching element includes a plurality of piercing elements which upstand on or parallel to the actuation axis, and wherein the piercing elements define a flap-creation device to create a flap from a capsule wall of the capsule.

3. (canceled)

4. The capsule-breaching head as claimed in claim 2, wherein the piercing elements define a rim of an arcuate discontinuous wall.

5. The detachable capsule-breaching head as claimed in claim 4, wherein the arcuate discontinuous wall is defined by two spaced-apart arcuate wall-parts.

6. (canceled)

7. The detachable capsule-breaching head as claimed in claim 4, wherein the discharge guide element includes a discontinuous truncated frusto-conical surface which forms at least part of an interior surface of the arcuate discontinuous wall.

8. (canceled)

9. (canceled)

10. The detachable capsule-breaching head as claimed in claim 1, wherein a plurality of said capsule-receiving chambers are in the first body part of the capsule-container body.

11. (canceled)

12. The detachable capsule-breaching head as claimed in claim 1, wherein said capsule-receiving chamber has a uniform or substantially uniform lateral extent along at least a majority of the longitudinal extent.

13. (canceled)

14. The detachable capsule-breaching head as claimed in claim 1, further comprising a biasing element which biases the first and second body parts away from each other.

15. The detachable capsule-breaching head as claimed in claim 1, wherein the closure element is rotatably engaged with the second body part.

16. The detachable capsule-breaching head as claimed in claim 15, further comprising a releasable locking element which prevents or limits relative movement of the first and second body parts when the closure element is angular displaced to close the capsule-receiving chamber and the discharge guide element.

17. The detachable capsule-breaching head as claimed in claim 1, wherein the closure element removably engages the first body part.

18. The detachable capsule-breaching head as claimed claim 17, wherein the closure element is positioned at or adjacent to the removable access cover.

19. The detachable capsule-breaching head as claimed in claim 18, further comprising a releasable locking element which prevents or limits relative movement of the first and second body parts when the removable access cover is engaged with the capsule-container body to close the access opening of the capsule-receiving chamber and the closure element is engaged with the first body part to close the capsule-receiving chamber and the discharge guide element.

20. A portable beverage-mixing device comprising a mixing body including a container to hold a liquid to be mixed with a powder discharged from at least one capsule; and a capsule-breaching head as claimed in claim 1 which is releasably engaged with an end of the said container, wherein the said guide element of the capsule-breaching head is in flow communication with an interior of the container.

21. The portable beverage-mixing device as claimed in claim 20, wherein the capsule-breaching head is screw-threadingly engaged with the said container.

22. The portable beverage-mixing device as claimed in claim 20, wherein said removable access cover of the capsule-breaching head is separately releasably engaged with the container.

23. The portable beverage-mixing device as claimed in claim 20, further comprising a releasable mixer body which is engaged with a second end of the said container and which is opposite the first said end.

24. The portable beverage-mixing device as claimed in claim 23, wherein the mixer body houses a power source, an electric motor to be energised by the power source, and at least one blending element to blend contents in the container and by which the electric motor is driven.

25. A capsule-breaching device comprising:
a capsule-container body,
at least one capsule-receiving chamber in the capsule-container body,
a capsule-breaching element which moves to breach a capsule received in the capsule-receiving chamber, and
a discharge guide element which guides a powder released from a capsule by the capsule-breaching element.

26. A detachable capsule-breaching head as claimed in claim 1, wherein the openable closure element sealingly closes the capsule receiving chamber.

27. (canceled)
